(19) United States
(12) Patent Application Publication
(10) Pub. No.: US 2021/0373649 A1
(43) Pub. Date: Dec. 2, 2021

(54) Attaching Extended Reality (XR) Content To Physical Points Of Interest

(71) Applicant: Rajesh Dayal Moorjani, New York, NY (US)

(72) Inventor: Rajesh Dayal Moorjani, New York, NY (US)

(21) Appl. No.: 16/837,927

(22) Filed: Apr. 1, 2020

(51) Int. Cl. G06F 3/01; G06T 15/04; G06T 17/20; G06T 19/00; G02B 27/01

(52) U.S. Cl. CPC G06F 3/011; G06T 15/04; G06T 17/20; G02B 2027/0187; G02B 27/0179; G02B 27/017; G06T 19/006

(57) ABSTRACT

A method and system involving the fixed attachment of extended reality (XR) content that may consist of one or more three-dimensional renderings and animation, two-dimensions stills and/or video along with text that can be attached to physical points of interests in a physical world environment using coordinate data, FOV data, calculating geometric meshes and surface information of the one or more points of interests along with the world environment.

### CROSS-REFERENCE TO RELATED APPLICATIONS

The present applications claims priority to the earlier filed U.S. provisional application having Ser. No. 62/830,485, filed Apr. 7, 2019 and hereby incorporates subject matter of the provisional application in its entirety.

### FIELD OF THE INVENTION

The area of invention is a system and method for attaching extended reality (XR) content to physical points of interests (POI).

### BACKGROUND

Descriptions of specific devices, techniques, and applications are provided only as examples. Various modifications to the examples described herein will be readily apparent to those of ordinary skill in the art.

Three-dimensional scenes contain many attributes such as 3D meshes, lighting, animation and digital characters. More people want to immerse themselves in these digital forms of content. Computing devices with head mounted displays (HMD) allow users to experience a level of immersion they are unable to experience on a flat screen sitting on a desk or from a smartphone in their hand.

Physical points of interest can be as unique as a finger print, where two similar objects can be identified with attributes that distinguish similar but unique objects based on several properties, including but not limited to, placement in world, objects near it, and items placed on it. It is this uniqueness that allows for curated XR content to be assigned to these one or more points of interest.

Users with a HMD can interact and explore virtual reality (VR), augmented reality (AR) or mixed reality (MR) worlds also, known as extended reality (XR) experiences.

Currently it is a multi-step and multi-platform method to attach XR content to a physical point of interest (POI) located in a physical space. It is a cumbersome process to work with different tools and computing platforms. The following invention will simplify and automate the process for people to attach XR content to the world around them.

The invention allows users with head mounted displays (HMD) to select physical points of interests (POI) in their physical environment and using their computing device and HMD, attach XR content to these POIs in order for themselves and others to discover and experience XR content around their physical world.

### SUMMARY OF THE INVENTION

The method and system described here represents one or more embodiments of attaching extended reality content (XR) to physical points of interests (POI) that are located in a physical environment. The computing device along with HMD using one or more sensors captures the environment's world mesh and surface information along with POI information and surface data and relative coordinates and FOV data of HMD and POI in the world environment. While using the HMD, the ability to assign selected XR content to the selected POI in the physical environment.

### BRIEF DESCRIPTION OF DRAWINGS

FIG. 1 shows person from a top view entering an indoor environment while wearing computing device with head mounted display, spots a physical point of interest in the indoor environment.

FIG. 2 shows an interior view of the indoor space, the person with the HMD has at least one or more image sensors to begin a geometric mesh query and process.

FIG. 3, the one or more image sensors scans the world environment and POI that results in capturing a geometric mesh and surface information of the world environment in the indoor space relative to the POI and person; the POI information and surface information is captured as well as capturing coordinates, FOV info as it relates to the HMD position in the environment.

FIG. 4 shows a close up view of the interaction between the HMD and POI, once mesh, surface, FOV and coordinate info is captured and calculated, XR content can be assigned to the POI.

FIG. 5 shows the assignment of XR Content as it relates to the POI.

FIG. 6 shows HMD sending wirelessly FOV info, POI information, world environment information, geometric mesh, surface data and positional coordinates captured by HMD to a remote computer.

FIG. 7 shows a user with HMD in an outdoor environment spotting POI in the outdoor environment.

FIG. 8 shows a user with HMD and one or more image sensors gathering world environment and POI data to determine geometric meshes and surfaces along with the mesh information of the world environment in the outdoor space relative to the POI and person and POI mesh information is captured as well as, the one or more sensors capture surface, coordinates and FOV data as it relates to the HMD position in the environment.

FIG. 9 shows a flow diagram of an example method of generating a unique digital model.

FIG. 10 shows a flow diagram of an example method of rendering a dynamic fixed view of XR content.

### DETAILED DESCRIPTION

It should be understood that processes and techniques described herein are not inherently related to any particular apparatus, system or method and may be implemented by any suitable combination of components.

It should be noted that while the following description is drawn to a computer/server based device interaction system, various alternative configurations are also deemed suitable and may employ various computing devices including servers, workstations, clients, peers, interfaces, systems, databases, agents, peers, engines, controllers, modules, or other types of computing devices operating individually or collectively. One should appreciate the use of such terms are deemed to represent computing devices comprising at least one processor configured or programmed to execute software instructions stored on a tangible, non-transitory computer readable storage medium (e.g., hard drive, FPGA, solid state drive, RAM, flash, ROM, memory, distributed memory, etc.). The software instructions preferably configure the computing device to provide the roles, responsibilities, or other functionality as discussed below with respect to the disclosed methods and systems. Further, the disclosed technologies can be embodied as a computer program product that includes a non-transitory computer readable medium storing the software instructions that causes a processor to execute the disclosed steps. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges among devices can be conducted over a packet-switched network, the Internet, LAN, WAN, VPN, or other type of packet switched network; a circuit switched network; cell switched network; or other type of network.

Historically three-dimensional (3D) content have been typically presented to users on a flat screen that is situated on a wall like a TV, on a desk like a laptop computer or on mobile phone held in one's hand. Recently, computing devices with head-mounted displays now allow users to enter these three-dimensional scenes where one can navigate around the 3D world or interact with 3D objects. The 3D content presents new avenues for entertainment, education, work and collaboration among other areas in one's life. This new form of experiencing digital scenes via HMD can be called extended reality or XR.

It will be understood when referring to XR content or Extended Reality content this encompasses digital content that can be presented in multiple immersive forms. Such as, Virtual Reality (VR), Augmented Reality (AR), Mixed Reality (MR), or two-dimensional text, image and video overlays on top of real world spaces, objects and living organisms.

Computing devices with Head-mounted displays or HMDs allows consumers to enter 3D worlds or interact with 3D objects or have 2D information overlaid the real world. For instance entertainment and gaming arenas have long used 3D content but presented on a flat screen like a TV or laptop or handheld device. Now with HMDs the consumer can enter the world created in 3D. Education arenas can immerse students into the curriculum where they can interact with a 3D digital form of the human body for medical learning, is one example. Another example is a group of students can attend a virtual field trip to space or visit a historical city without leaving the classroom. A factory worker can make repairs on machinery without having to hold a separate manual and can have the instructions overlaid the actual machine and receive step by step instructions on how to perform the repair. The same factory worker can use HMDs to track inventory throughout the factory floor without having to lose sight of it. A designer can create model to scale while standing in their physical world. No longer needed to be bound by a small flat screen but can use the physical environment as a canvas to design while in a HMD. A user when looking for a specific address can put on a HMD and get map instructions to where to go while walking over and can get environment information of the objects and landmarks he/she passes by. Digital content overlaying the real world in the HMD in such a manner can be a powerful reference tool.

Currently for creators to develop XR content and place it in the physical world, they have to go through a multi-step and multi-platform process. Current techniques require multiple devices to calculate the world environment the creator is in, select and scan and digitize one or more points of interest, select XR content to position in world environment as it relates to the POI, then account of the creator's FOV to render the content appropriately. This adds cumbersome challenges to creation and distribution of such content. The invention proposed will reduce the time and automate the process for creators to select one or more physical points of interest, scan the selection, calculate the world environment, obtain XR content and assign it to the one or more physical POI in a efficient and unified way.

The illustrative embodiments described in the detailed description and figures are not meant to be limiting. Other embodiments may be utilized, and other changes may be made, without departing from the spirit or scope of the subject matter presented herein.

Indoor Environment with POI

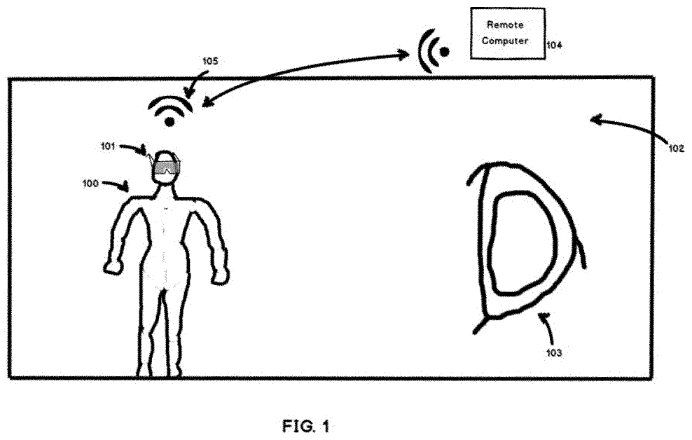

FIG. 1 shows a user (100) from a top view entering an indoor environment (102) the person (100) is wearing a computing device with head mounted display, a HMD, (101). The HMD with computing device may have one or more sensors attached to it. The person spots one or more physical points of interest, POI, (103) in the indoor environment. The HMD can communicate wirelessly (105) to a remote computer (104).

The computing device can be any small structured device with a CPU.

The HMD can be eyeglasses, goggles, hat, helmet, a visor or other head mounted form factor.

Wireless communication can be a radio frequency such as RFID, NFC, beacon, Bluetooth, wifi, ultrasonic RF, cellular or a optical signal which may include barcode, QR code, computer vision recognition.

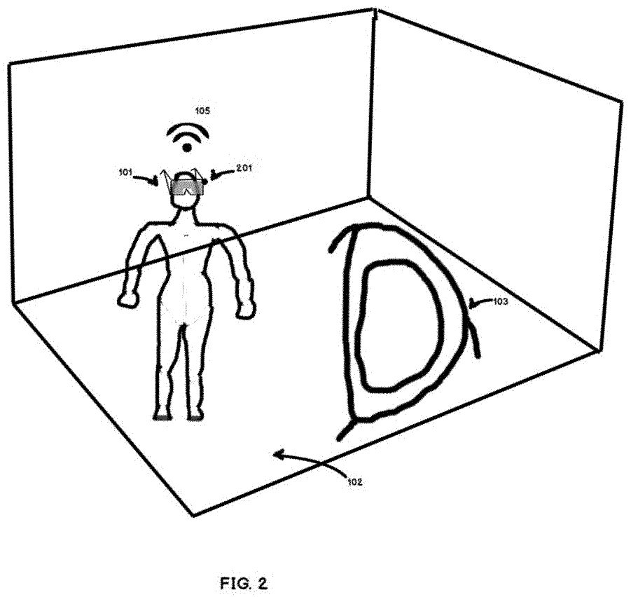

FIG. 2 shows an interior view of the indoor space (102), the person with the HMD (101) may have one or more image sensors (201) attached to it. The user is walking around the physical environment and identifies POI (103) within the physical environment. The image sensor begins the geometric mesh query and process to determine the world environment, POI information along with any surface and coordinate data.

Image sensor can be a still camera, video camera, depth sensor, infrared, structured light, etc.

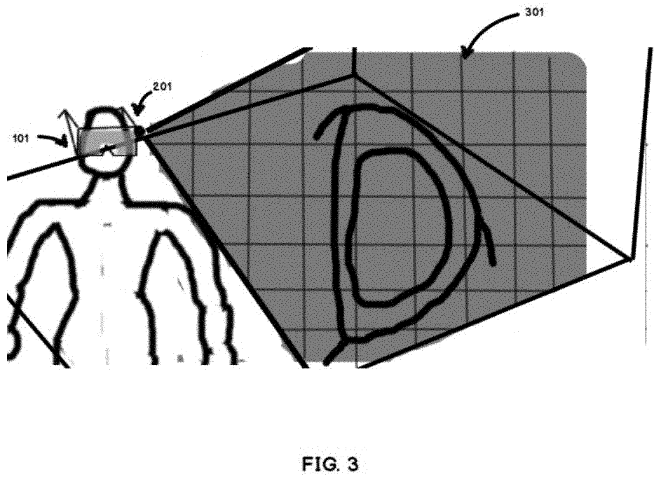

FIG. 3, the one or more image sensors (201) begin a scan of the world environment and POI (301). The resulting one or more geometric meshes and surface information of the world environment in the indoor space relative to the POI; and FOV data of person; and POI and surface information is captured. Along with meshes, surface data and textures, the HMD device captures coordinates info as it relates to the HMD positions in the environment.

The world environment mesh can be face meshes, surface meshes, geometric data, point cloud, polygons, three-dimensional based representation.

POI information, which can be one or more 3D models, which has textures, dimensions, mesh, mappings, geometric data, animation data.

World environment mesh establishment can be through references stored on a remote computer, recreated by the user, a Artificial Neural Network (ANN) recreates the meshes, can be a point cloud captured by image sensors, can be geometric data, ANN establishes world space coordinates (captured or recreated).

POI models can be captured by the user using image sensors, can be referenced in a remote computer, can be established by ANN, can be made of point clouds, can be geometric data.

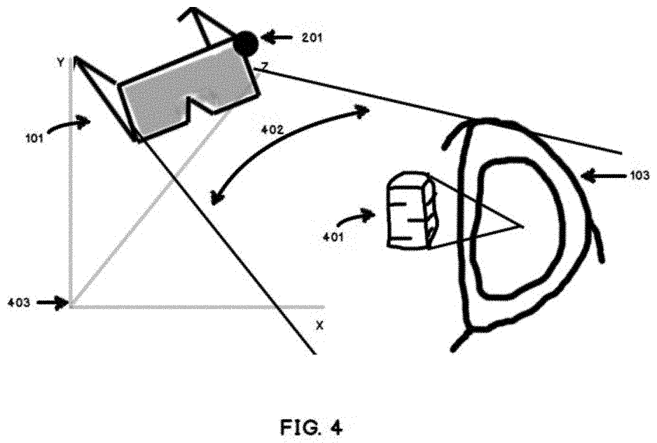

FIG. 4 shows a close up view of the interaction between the HMD (101) and POI (103). The user wearing HMD (101) initiates a command input to select POI (103). Mesh, texture, FOV (402) and coordinate (403) info is captured and calculated. The coordinate info of HMD and POI relative to each other and its relation to the world environment is captured as well. Once the data is gathered and collected, XR content (401) can be assigned to the POI (103).

The FOV can be field of view, point of view, head pose or gaze.

Extended Reality (XR) content can consist of Mixed reality, Augmented reality, Virtual reality, 3D graphics, 2D text, 2D images, 2D video and audio.

POI information is sent to a rendering engine. The rendering engine takes in the dimensions of the POI, object outlines, derives geometric primitives, assigns mapping labels and image textures, rigging is added if applicable and outputs a 3D POI digital model render.

The digital model is placed in a scene that mimics the current world space. The rendering engine takes background data of where the POI is and then cuts out the POI from the world space scene and replaces it with an inpainted background. The 3D POI can now be separated from the surrounding environment.

The POI is now a morphable 3D digital rendering that can be manipulated by the user.

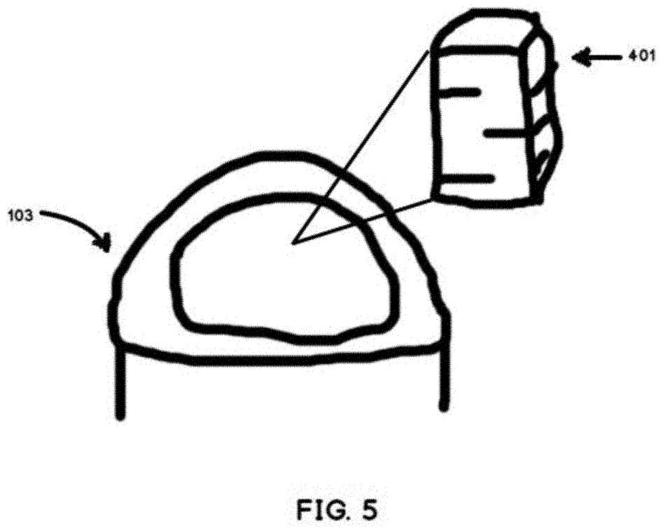

FIG. 5 shows once the user selects the POI (103) and the POI (103) is digitized, XR content (401) can be assigned as it relates to the POI (103).

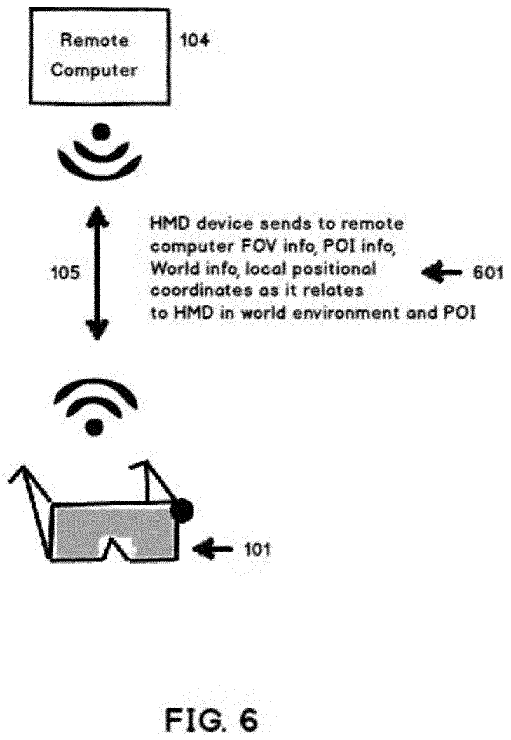

FIG. 6 shows the HMD (101) sending wirelessly (105) the HMD (101) FOV info; POI data; world environment data and positional coordinates as it relates to the HMD in the world environment and POI (601) to the remote computer (104). The remote computer compares the captured mesh data to stored mesh data in the remote computer related to that location. Based on the captured info by the HMD along with computing device and if any world mesh data on the remote computer is located, a current geometric primitive world mesh and surface data is established.

That content ID is now broadcasted wirelessly in the environment; that broadcast can be in form of a wifi-signal or a specific RF indicia signal. There could also be a unique QR code visible in the environment space that is produced or an audible sound that has indicia to the XR content associated to the POI.

The remote computer may be one or more servers, databases, rendering engines or networked computing devices.

Outdoor Environment with POI

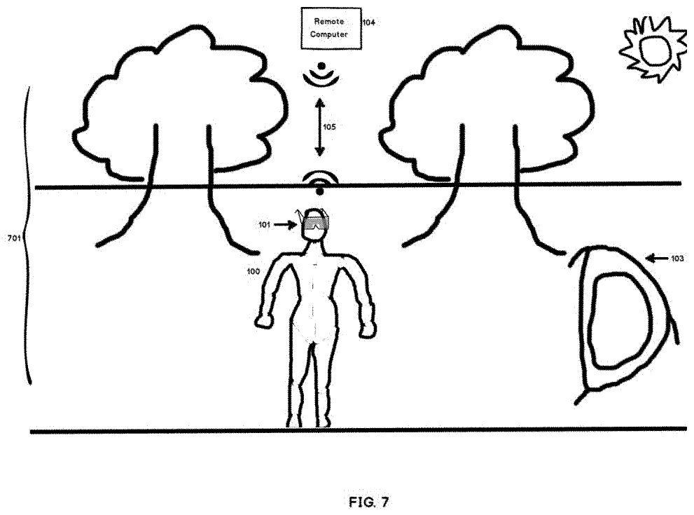

FIG. 7 shows a user (100) in an outdoor environment (701) the user (100) is wearing a computing device with head mounted display, a HMD, (101). The HMD with computing device may have one or more sensors attached to it. The person spots a physical point of interest, POI, (103) in the outdoor environment. The HMD can communicate wirelessly (105) to a remote computer (104).

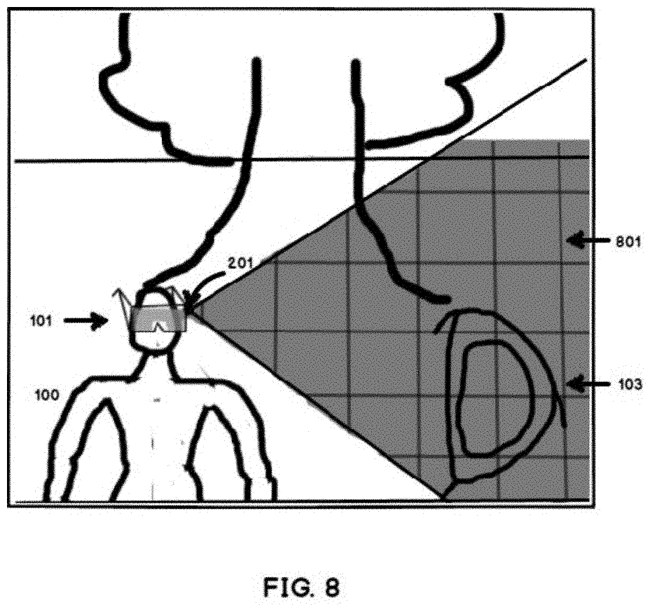

FIG. 8 shows user (100) with HMD (101) and one or more image sensors (201) scanning (801) the outdoor world environment and POI to capture geometric meshes and surface information. The resulting geometric mesh and surface information of the world in the outdoor environment (701) relative to the POI; and FOV data; and POI information and surface information is captured. Along with mesh and surface, the HMD device captures coordinates info as it relates to the HMD position in the world environment.

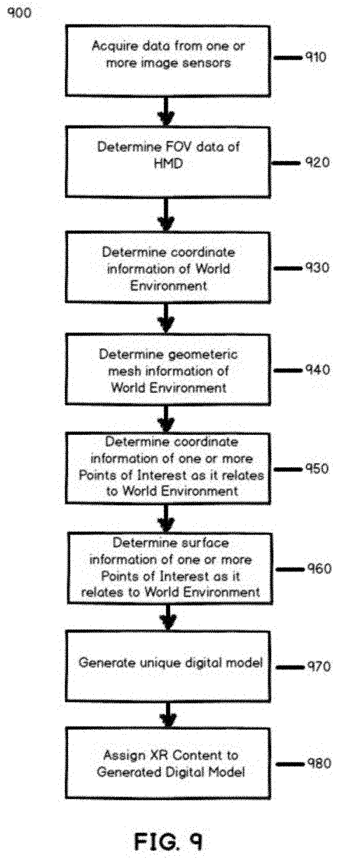

FIG. 9 shows a flow diagram of one embodiment of an example method 900 to generate a unique digital model. In STEP 910 using one or more image sensors to acquire data of world environment and one or more points of interest. Determine FOV data of HMD (STEP 920) in world environment. Determine geometric mesh information of world environment (STEP 940). Determine coordinate information of world environment (STEP 930) and coordinate information of one or more POI as it relates to world environment (STEP 950). Determine surface information of one or more POI (STEP 960). Based on one or more POI and world environment, generate a unique digital model (STEP 970). Assign XR content to generated digital model (STEP 980).

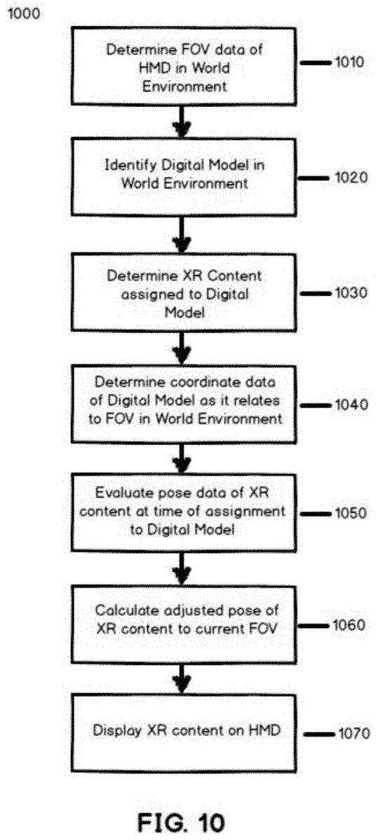

FIG. 10 shows a flow diagram of one embodiment of an example method 1000 rendering a fixed view of XR content. In STEP 1010 determine FOV data of HMD in world environment. Identify digital model in world environment (STEP 1020). Determine XR content assigned to digital model (STEP 1030). Determine coordinate data of digital model in world environment as it relates to FOV (STEP 1040). Evaluate pose data of XR content at time of assignment to digital model (STEP 1050). Calculate adjusted pose of XR content as it relates to current FOV (STEP 1060). Display XR content on HMD (STEP 1070).

The world environment can be a room, park, city block, museum space, art gallery, office, conference room, showcase area, retail store, restaurant, bar, store window, lobby, apartment, house, historical landmark.

Points of Interest which could be an physical object, person, vehicle, group of objects, wall, corner, floor spot, furniture, trees, plants, pets, children, books, newspapers, magazines, pamphlets, posters, billboards, buttons, clothing.

It should be noted that many variations of the described processes are possible. Although the present embodiments have been described with reference to specific example embodiments, various modifications and changes can be made to these embodiments without departing from the broader spirit and scope of the various embodiments.

### Use Cases: Indoor Space

### An Exhibit Space

A curator wearing a HMD enters an indoor physical space that is set up with exhibits, artifacts, paintings, etc. to showcase to visitors of the space. The curator while wearing the HMD walks over to a specific exhibit (a physical POI), looks over at the POI and selects it, then with user based inputs, selects XR content which may consist of a 3D graphic, animation, audio and/or accompanying text that presents the history of the exhibit, positions the XR content on the exhibit, a POI content id is created and stored on a computing device and the ID can be broadcasted wirelessly to other users wearing a HMD while in the physical space.

### A Residence Such as a House, Apartment, Dormitory

A tenant or owner of the residence walks in, while wearing the HMD, walks over to a corner of the room they are in, selects a POI, in one case it is a coffee table, while looking at the coffee table, the user selects the XR content experience such as a 3D board game and positions it on the coffee table, the POI id is created, stored and can be broadcasted wirelessly to users in the room.

### A Warehouse

A worker on the floor is walking around the warehouse, sees a pallet of boxes, walks over to the pallet and while wearing the HMD is looking at the boxes, selects XR content information that includes inventory data of the boxes and 3D representations of what's inside the boxes, the user positions the XR content onto the boxes, the POI id is created, stored and can be broadcasted wirelessly to users inside the warehouse.

### An Office Floor

A employee enters into the floor of his/her office while wearing a HMD walks over to a desk, selects the desk as a POI, based on user input commands, places XR content such as virtual screens, 3D photos, digital to-do lists around the desk, once placed and positioned a POI id is created, stored and can be broadcasted wirelessly to all users on the office floor.

### A Retail Store

The store manager wearing the HMD enters the store, walks over to a display setup with the latest retail items for sale, the manager looks at the display and selects the display as the POI, using input commands places XR content that is a 3D animation that describe the items for sale, the XR content is positioned on the display, a POI id is created, stored and can be broadcasted wirelessly to users who enter the retail store.

### A Living Room

An interior decorator, selects a bookshelf, while wearing the HMD the decorator can select the bookshelf and transform into table or move the bookshelf as the physical object becomes the XR content itself. once the XR content is placed a POI id is created, stored and can be broadcasted wirelessly to users who pass by the structure in the indoor playground.

### Store Window

A store manger physically decorates the store window of a retail outfit, while wearing the HMD, the managers, select the decorations as the POI, based on input commands, while wearing the HMD, place XR content such as 3D animations that tell a story of the window display and plays spatial audio, once positioned a POI id is created, stored and can be broadcasted wirelessly to users who pass by the store window.

### A Indoor Playground

A indoor theme park organizer creates certain areas and structures for entertainment, is walking around the space and looking at a physical structure, while wearing the HMD the organizer selects the structure and positions XR content onto the structure, the XR content is a mix of spatial audio and 3D graphics and may include 2D photos and text to enhance the playfulness of the structure, once the XR content is placed a POI id is created, stored and can be broadcasted wirelessly to users who pass by the structure in the indoor playground.

### Use Cases: Outdoor Space

### A Park

A park guide is walking through a park and spots a statue, while wearing the HMD, the guide walks over to the statue and looks at it, using input commands, selects the statue as a POI, pulls up XR content that has biographical video, text and animations describing the history of the statue, places the XR content onto the statue, once XR content is placed a POI id is created, stored and can be broadcasted wirelessly to users who pass by the statue.

### A City Block

A tour guide is walking a historic block in a metropolitan city, the guide spots a landmarked corner, while wearing the HMD, the guide walks over to the corner, looks at the spot and using input commands, selects the corner as a POI, then pulls up XR content that shows a 3D animated rendering of the corner as it was several decades ago, once the XR content is placed a POI id is created, stored and can be broadcasted wirelessly to users who pass by the corner.

### A Suburban Neighborhood

A real estate agent is passing through a neighborhood, the agent has a house listed for sale in the neighborhood, while wearing the HMD, the agent walks over to the house and selects it as a POI, using input commands, pulls up XR content that gives a description, video and photos of the house as well as a 3D rendering of the interior, once the XR content is positioned a POI id is created, stored and can be broadcasted wirelessly to users who pass by the house.

### A College Campus

A student is creating a scavenger hunt for her fellow students on the campus, the student while wearing a HMD spots particular decorative boulder around the center of campus, the student walks over to the boulder and selects it as a POI, using input commands, the student places XR content that consists of 3D effects and image panels, once the XR content is positioned a POI id is created, stored and can be broadcasted wirelessly to users who pass by the boulder.

Finally, it should be understood that processes and techniques described herein are not inherently related to any particular apparatus, system or method and may be implemented by any suitable combination of components. Further, various types of general purpose devices may be used in accordance with the teachings described herein. The present invention has been described in relation to particular examples, which are intended in all respects to be illustrative rather than restrictive. Those skilled in the art will appreciate that many different combinations of hardware, software, and firmware will be suitable for practicing the present invention.

Moreover, other implementations of the invention will be apparent to those skilled in the art from consideration of the specification and practice of the invention disclosed herein. Various aspects and/or components of the described embodiments may be used singly or in any combination in the systems and methods for associating XR content to physical points of interests and retrieving the previously associated XR content.

What is claimed:

1. A method for extended reality (XR) content comprising of: determining field of view (FOV) of at least one head mounted display (HMD) in world environment; determining geometric mesh information of world environment as it relates to one or more points of interest (POI); determining surface information of one or more POI; generating a digital model based on one or more POI information as it relates to world environment information; assigning XR content to generated digital model as it relates to FOV.

2. The method of claim 1, further comprising of determining coordinate information of world environment.

3. The method of claim 1, further comprising of determining coordinate information of one or more points of interest as it relates to world environment.

4. The method of claim 1, wherein determining surface information comprises of determining texture mapping of one or more points of interest as it relates to world environment.

5. The method of claim 1, wherein generating digital model comprises of determining geometric faces of the digital model.

6. The method of claim 1, wherein assigning XR content to the digital model comprises of determining pose information of XR content.

7. A system for extended reality (XR) content comprising of: at least one head mounted display (HMD); one or more image sensors; one or more processors configured to: determining field of view (FOV) of at least one head mounted display (HMD) in world environment; determining geometric mesh information of world environment as it relates to one or more points of interest (POI); determining surface information of one or more POI; generating a digital model based on one or more POI information as it relates to world environment information; assigning XR content to generated digital model as it relates to FOV.

8. The system of claim 7, further comprising of acquiring data from one or more image sensors.

9. The system of claim 7, further comprising of determining coordinate information of world environment.

10. The system of claim 7, further comprising of determining coordinate information of one or more points of interest as it relates to world environment.

11. The system of claim 7, wherein determining surface information comprises of determining texture mapping of one or more points of interest as it relates to world environment.

12. The system of claim 7, wherein generating digital model comprises of determining geometric faces of the digital model.

13. The system of claim 7, wherein assigning XR content to digital model comprises of determining pose information of XR content.

14. A method for fixed view of extended reality (XR) content comprising of: acquiring field of view (FOV) at least one head mounted display (HMD) as it relates to world environment; identifying world environment; identifying one or more points of interest (POI) in world environment; obtaining a digital model based on identified world environment information and identified one or more POI information; obtaining XR content assigned to digital model; calculating pose of XR content as it relates to FOV in world environment.

15. The method of claim 14, wherein acquiring FOV of display device comprises of obtaining coordinate position of HMD as it relates to world environment.

16. The method of claim 14, wherein referencing surface information comprises of obtaining texture mapping of one or more points of interest as it relates to world environment.

17. The method of claim 14, wherein obtaining digital model comprises of obtaining coordinate position of digital model as it relates to world environment.
